(19) United States
(12) Patent Application Publication
(10) Pub. No.: US 2014/0324815 A1
(43) Pub. Date: Oct. 30, 2014

(54) SEARCH INFRASTRUCTURE REPRESENTING HOSTING CLIENT DEVICES

(71) Applicant: BROADCOM CORPORATION, Irvine, CA (US)

(72) Inventors: Wael William Diab, San Francisco, CA (US); Yasantha Nirmal Rajakarunanayake, San Ramon, CA (US); James Duane Bennett, Hroznetin (CZ)

(21) Appl. No.: 13/902,467

(22) Filed: May 24, 2013

Related U.S. Application Data
(60) Provisional application No. 61/816,898, filed on Apr. 29, 2013.

(51) Int. Cl. G06F 17/30

(52) U.S. Cl. CPC G06F 17/30864
USPC 707/709; 707/770; 707/711

(57) ABSTRACT

A system and method for supporting searching of client device hosted content. A search infrastructure supports creation, managing and searching of client device hosted content. A client device, which hosts content, communicates its client device identification (ID), type and access restrictions to the search infrastructure. In addition, the client device communicates a global network route to the client device content as a pointer for the search engine to provide a search requestor access to both the client device and specified content. Client device information is also provided to a client device registry accessible by the search infrastructure, for example a registry maintained in a cloud based service. Client devices can enter into client device services agreement with a third party storage system for the purposes of providing a higher probability that their client device hosted content will be available.

### CROSS REFERENCE TO RELATED APPLICATIONS

The present U.S. Utility patent application claims priority pursuant to 35 U.S.C. §119(e) to U.S. Provisional Patent Application Ser. No. 61/816,898, entitled “Search Infrastructure Representing Hosting Client Devices,” filed Apr. 29, 2013, pending, which is hereby incorporated herein by reference in its entirety and made part of the present U.S. Utility patent application for all purposes.

### BACKGROUND

1. Technical Field

The present disclosure described herein relates generally to internet searching infrastructures and more particularly to client hosted content and searching thereof.

2. Description of Related Art

Current web search engine infrastructures use web crawling of web page hosting servers to identify hosted web pages and media content. Text within each identified web page is pre-processed and added to reverse indexed databases. Media content (e.g., images) may also be preprocessed and added to media characteristic databases. Such media content and hosted web pages are also often cached by web search infrastructure. Because web page and media content volume continues to grow exponentially, improving the preprocessing and storage requirements grows in importance.

In addition, currently, a client device uploads content to a web server for hosting so that such server can expose such content to others via web searching. This requires finding a hosting service, engaging an uploading process, and otherwise intentionally interacting in a time consuming process. Otherwise, establishing connections from one client device to another for direct retrieval of client content is also often difficult, if not impossible for many users.

### BRIEF DESCRIPTION OF THE DRAWINGS

FIG. 1 is a system diagram illustrating a communications environment embodiment in accordance with the present disclosure;

FIG. 2 is an internet search infrastructure diagram illustrating one embodiment in accordance with the present disclosure;

FIG. 3 is an internet search infrastructure diagram illustrating another embodiment in accordance with the present disclosure;

FIG. 4 is an internet search infrastructure diagram illustrating yet another embodiment in accordance with the present disclosure;

FIG. 5 illustrates a client device flow diagram showing one embodiment in accordance with the present disclosure;

FIG. 6 illustrates a client device flow diagram showing another embodiment in accordance with the present disclosure; and

FIG. 7 illustrates a search system infrastructure flow diagram showing one embodiment in accordance with the present disclosure.

### DETAILED DESCRIPTION

In one or more embodiments of the technology described herein, a system and method is provided to support client devices directly hosting web content via web search infrastructure support. In these embodiments, personal devices (including tablets, smartphones, laptops, STB's and other home entertainment devices, AP's, home NAS, etc.) become part of an overall web search storage infrastructure. Search index data and other search data are extracted via pre-processing of client content to support web searching spanning both traditional server hosted content but also device hosted content. In example embodiments, this will involve often roaming client devices participating in content hosting. Such client content includes, for example, media, data, programs/apps, services, files, etc., and in some embodiments, extends to client hosted web page data as well.

Search databases will point (user device IP address and login information) to particular content stored at the client devices. Search results will identify web hosting server content (traditional approach) plus client hosted content in combined or separately tabbed or filtered formats. To support servicing search requests, the search infrastructure processes received and stored hosted content to extract indexed database data to be added to its search database infrastructure of reverse text indexes, associated hypertext linkages, associated IP addresses, media characteristic data, etc.

In one embodiment, in addition to storing search database data relating to client device content, the content itself is stored and hosted. Because client devices are often unreliable in providing adequate and uninterrupted hosting services, the search infrastructure stands in to support same via caching or full backup support. Client devices, in one or more embodiments, contract for such services and pay in a manner not much different from that associated with web server hosting. For example, in one embodiment, a client device chooses to pay, upload content while never providing hosting services as the search infrastructure will handle it for them.

In one or more embodiments, another client device (or the same device but in relationship to other client data/services) chooses to handle the hosting itself (i.e., as in described above) or a third client device chooses to handle whatever it can host but have the search infrastructure step in to provide hosting services when the third client device is fully engaged.

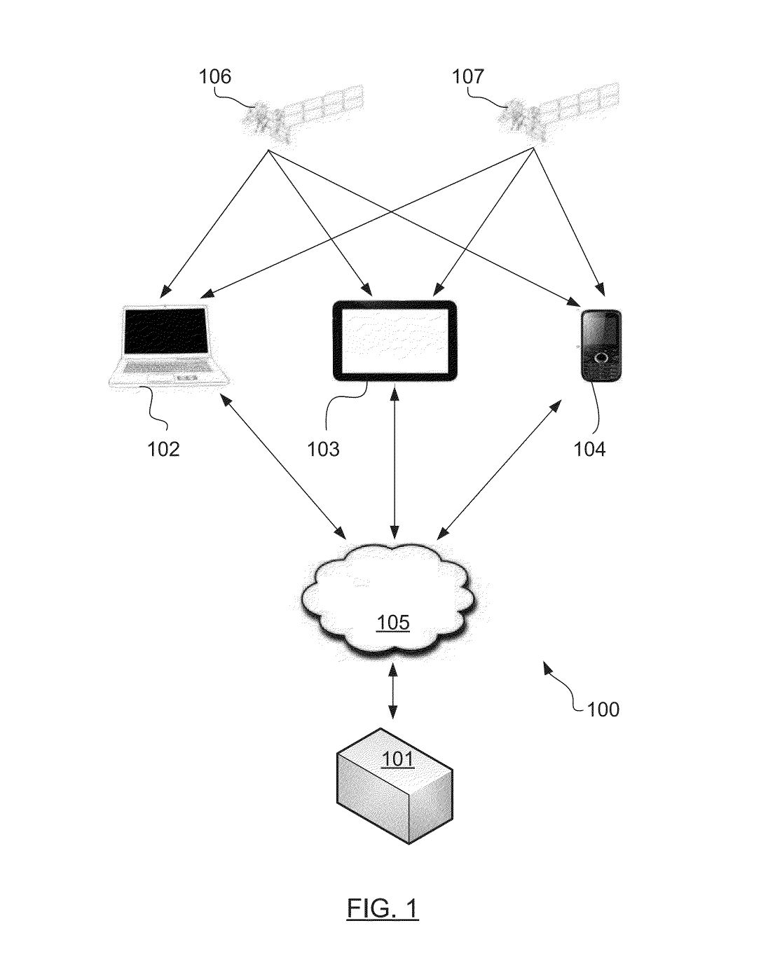

FIG. 1 is a system diagram illustrating an embodiment of a communications environment in accordance with the present disclosure. System 100 includes search system 101 connected to a plurality of mobile communication devices, for example, laptop 102, tablet 103 and smartphone 104, connected via network 105 and in geographically distinct locations. Network 105 may include any known or future communications network, structure and/or standard such as, but not limited to, 3G (Third Generation), 4G (Fourth Generation), LTE (Long-term Evolution), GSM (Global System for Mobile Communications), Wi-Fi, WiMax, WLAN (wireless area network), a WAN (wide area network), a LAN (local area network) and MIMO (Multiple Input Multiple Outputs).

In one embodiment, laptop 102 is used to originate content (e.g., images, video, audio, programming source code, text, database data, etc. in any one of a plurality of file format types). Offloading search system's 101 support responsibilities, laptop 102, in one or more embodiments, preprocesses its originated content to generate at least one search format output that can be uploaded and consumed by search system 101 into its underlying search database infrastructure. After receiving and integrating such search format output, search system 101 receives a search input from tablet 103 that targets the content currently stored on laptop 102. Search system 101 uses the search input in searching database data to identify such content in search results. Thereafter, tablet 103 may interact via the search results and laptop 102 to gain access to the stored content. Instead of, or in addition to, local storage for future search servicing, the originated content itself may be uploaded (along with the preprocessed search format output) for storage within search system 101 to support content delivery from search system 101 to tablet 103 based on search result interaction. Laptop 102 may also further supplement such upload with status information, payment requirements, searcher restrictions, DRM (digital rights management) requirements, loading information, hosting characteristics, scheduling information, etc.

In one or more embodiments, the mobile communication devices are in communication with GPS satellites 106 and 107, and/or terrestrial based location providing services to provide the mobile communication devices with location information. In alternative embodiments, location information for the mobile communication devices is obtained using other information such as media access control (MAC) address, internet protocol (IP) address, or equivalents known or future.

While mobile communication devices 102 to 104 illustrated as laptop 102, tablet 103 and smartphone 104, they are interchangeable with any mobile communications device such as: a cellular telephone, a local area network device, personal area network device or other wireless network device, a personal digital assistant, personal computer, laptop computer, wearable computers, tablet computers or other devices that perform one or more functions that include communication of voice and/or data via a wireline connection and/or the wireless communication path. In yet other embodiments, mobile communication devices 102 to 104 are an access point, base station or other network access device that is coupled to network 105 such as the Internet or other wide area network, either public or private, via a wireline or wireless connection.

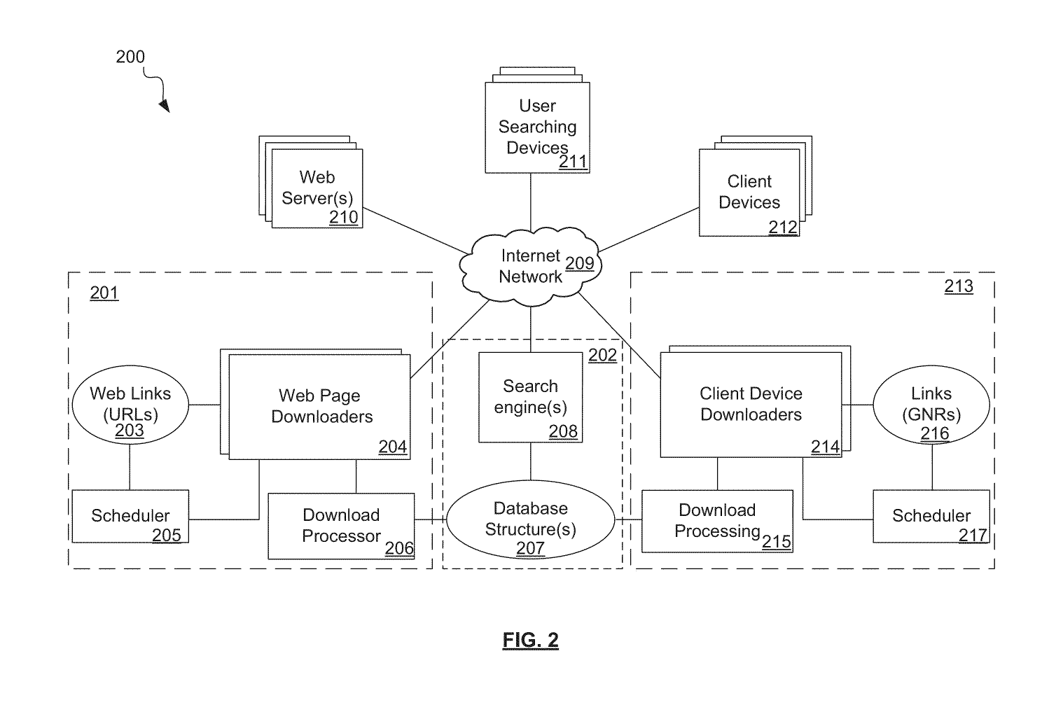

FIG. 2 is an internet search infrastructure diagram illustrating one embodiment in accordance with the present disclosure. Internet search infrastructure 200 includes search system infrastructure components web crawler 201, client device crawler 213 and search engine infrastructure 202. Web crawler 201 includes one or more processing modules 203-206 which systematically browse the World Wide Web (WWW), typically for the purpose of building a database of web based content. Web crawler 201 uses a list of web links (pointers) supplied by link module 203 such as uniform resource locators (URLs) to visit. The URLs are called seeds as they start a process of content discovery and typically are provided by domain registrations. As the crawler visits these URLs, one or more web page downloader module(s) 204 parse the URLs to identify unique hyperlinks in the page, which point to web server 210 to stored content. URLs are typically recursively visited according to a set of policies, which detect structure and content. As links are traversed, web pages and specific content are downloaded by web page downloader module(s) 204 as per a schedule dictated by scheduler module 205.

Web page downloader module(s) 204 will interact with each web server to manage content related uploads into the search infrastructure 200. A first group of web servers 210 will act in conventional ways by providing content in native formats (html, xml, jpg, mp3, pdf, etc.) without preprocessing of the content. In addition to providing such content uploads, a second group of web servers 210 will also upload associated preprocessing output, i.e., at least one search format output that is more easily consumed into the search database structure 207 of the search engine infrastructure 202. A third group of web servers will provide such preprocessing output uploads, but without content uploading.

In one embodiment, web page downloader module(s) 204 further include preprocessing of webpages. Preprocessing, typically performed by web server(s) 210, includes extracting, in one embodiment, non-text information about images. This information includes, for example, whether the image is black and white, a sketch, drawing file, full color, a photograph, clip art, facial recognition, age/sex id (i.e., adult, child, senior, male, female, etc.). In addition, in one embodiment, access information is extracted such as public, private, sharing lists, grouping, download and distribution rights, security, or access based on income, gender, age, location, citizenship, relationships, membership, etc.

Download processor module 206 reverse indexes a selected web page to encode web page words (e.g., frequency) while noting a location on the associated page (offset) so that content can be recovered (extracted) at a later time. The indexed data is stored in memory of database structure 207 (search database) where it is stored for later access by search engine(s) 208. In addition to web page words, all Multipurpose Internet Mail Extensions (MIME) (file types and formats) can be preprocessed by dedicated processing elements so as to produce something that can easily be integrated into a search database structure to support searching. Other examples include, but are not limited to, .mp3 files being analyzed to identify pop, jazz, or other music type, versus child, animal, adult female voices, etc. Image analysis and categorization such as line drawing, sketch, black and white, painting scan, watercolor, content identity: face, architecture, landscape, group of humans, object identification, face identification (actual name determination), etc.; program code language, underlying functions, operating environments, programmers, updates, version, copyright, etc., as determined from the code file and file format; text within any content file format (such as reverse indexing word and pdf files or via OCR's (optical character recognition) associated with scanned text or image text. Common database needs to (reverse) index parameters and text into a common structured format, while breaking down the obligation to search and process across each MIME types repeatedly. While such preprocessing could take place centrally, offloading at least a portion of the preprocessing duties to either clients or both of the web servers reduces workload requirements for any of the devices.

In one or more embodiments, database structure 207 includes indexes of unique words with associated index pointers (URLs) and web page position information. Unique words are hashed using a hash table. A hash table (also hash map) is a data structure used to implement an associative array, a structure that can map keys to values. A hash table uses a hash function to compute an index into an array of buckets or slots, from which the correct value can be found. Unique words are typically arranged by frequency (e.g., highest to lowest) and also carry importance using frequency ranking. For example, in the phrase “the cat”, the word “the” is not important and the word “cat” is important. Rare words are often given highest importance along with strings of words and rare strings of words.

Internet Network 209 is a global system of interconnected computer networks that use the standard Internet protocol suite (TCP/IP) to serve billions of users worldwide. It is a network of networks that consists of millions of private, public, academic, business, and government networks, of local to global scope, that are linked by a broad array of electronic, wireless and optical networking technologies. The Internet carries an extensive range of information resources and services, such as the inter-linked hypertext documents of the World Wide Web (WWW) and the infrastructure to support email. The internet network is used to interconnect the various elements of system 200 and is implemented using known and future communication infrastructures such as wireless and wired networks including, but not limited to, wireless local area networks (WLANs), wide area networks (WANs), local area networks (LANs), Ethernet, fiber optic or other known or future communication network infrastructures. Internet Network 209 interconnects web servers 210, user searching devices 211 and client devices 212, to the search system infrastructure (201, 202 and 213) which use the indexed data to match a user input search string from user search device 211 (e.g., smartphone, tablet, laptop, desktop or other known or future user devices with communications capabilities).

The internet search infrastructure of FIG. 2 is, in one or more embodiments described herein, also in communication with one or more GPS satellites and/or terrestrial geographic location systems (FIG. 1 elements 106 and 107) that provide the one or more communication devices with location information. In alternative embodiments, location information for one or more communication devices is obtained using other information such as a media access control (MAC) address, an internet protocol (IP) address, or the like.

In one or embodiments of the technology described herein, internet search infrastructure 200 includes client device generated and/or hosted data. Client device generated data includes creation of content by users of client devices 212 (e.g., mobile communication devices 102 to 104). Once new content is created by the user of client device 212, the data is stored locally (e.g., in memory on the client device 212 with an associated pointer to the content) or remotely (e.g., within the search system infrastructure and/or in the cloud including, for example, third party servers with a modified pointer). Created client device content includes, in one embodiment, downloaded content and/or aggregated content on the client device.

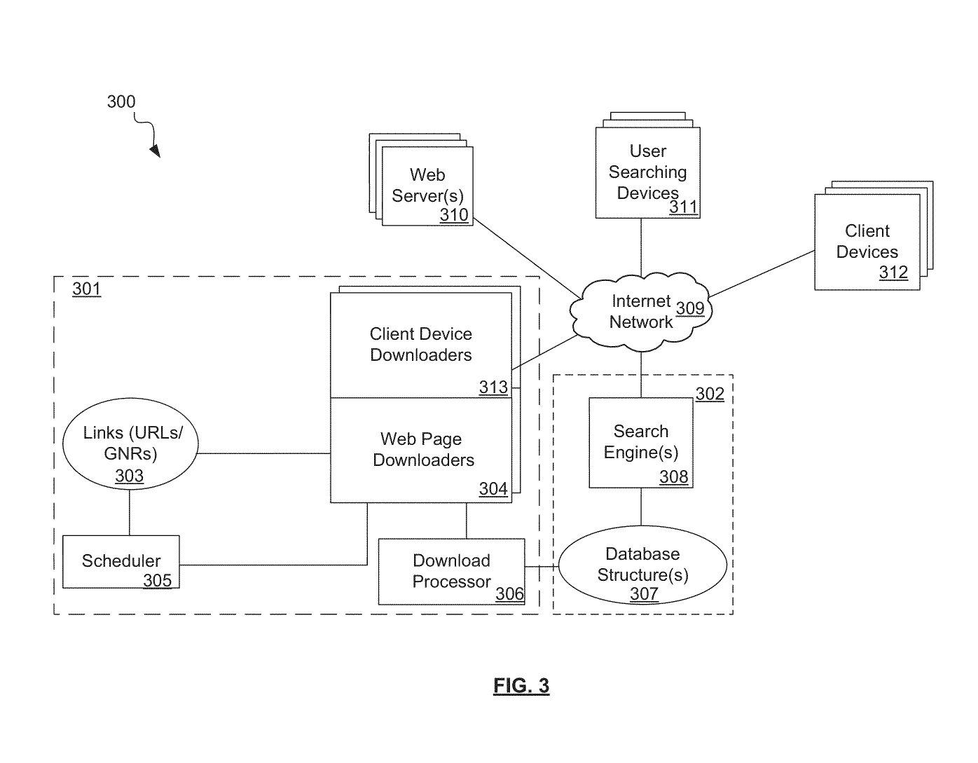

Content hosted by client device 212 (client device content) is supported within the search system infrastructure by client device content crawler 213 which mirrors the web crawling elements 201. While shown as separate crawlers, web and client device crawling functions can, in one embodiment, be combined into a single crawler system providing crawling for both web and client hosted content. Client device content crawling system 213 accesses and parses content (data) stored in memory (shown in FIG. 3, element 305) on one or more client devices 212 in much the same way a traditional web crawler would crawl a web page located on a web server. The client device content crawler 213 includes, but is not limited to, one or more client device downloader modules 214 which access and process (e.g., parse) the content hosted by the client device in a similar fashion to web pages for downloader module 204. Client device downloader module(s) 214 can, in one or more embodiments, receive a link/pointer (such as a global network route) which is a unique path to client device content and/or associated content) from link module 216, download the content itself directly from the client device or a download a copy of the client device hosted content from a client device designated storage location external to the client device. In addition, access data (e.g., client device identification, client type, and client status) is made available to the downloader modules to provide access to the content/associated content (e.g., preprocessed content). In one embodiment, the client device provides the pointer and access data to a client device registry 218, for example a registry maintained in memory within a cloud based service which is accessible by the search system infrastructure (downloader module). The client device content crawling system 213 further includes scheduler module 217 to schedule the crawling of the client device created/stored content and download processor module 215 to reverse index the client device hosted content and distribute to database structure 207 which is accessible by search engine(s) 208 and user searching devices 211.

User searching devices 211 include, but are not limited to: mobile phones; smartphones; tablets; laptops; desktops; or other known or future user computing devices with communications capabilities. In one or more embodiments disclosed herein, mobile communication devices are the recipients of the preprocessed, indexed and stored search system infrastructure output. These mobile communication devices are, in one or more embodiments, a mobile phone such as a cellular telephone, smartphone, a local area network device, a personal area network device or other wireless network device, a personal digital assistant, a personal computer, a laptop computer, wearable computers (e.g., heads-up display (HUD) glasses), tablet computers or other devices that perform one or more functions that include communication of voice and/or data via a wireline connection and/or the wireless communication path. Additionally, in one or more embodiments, mobile communication devices are an access point, base station or other network access device that is coupled to a network such as the Internet or other wide area network, either public or private, via a wireline/wireless connection. Please note, while shown as separate devices for functional clarity, user searching devices can also be client devices and vice-versa (e.g., using smartphones or tablets).

FIG. 3 is an internet search infrastructure diagram illustrating another embodiment in accordance with the present disclosure. Internet search infrastructure 300 includes a search system infrastructure including crawler 301 and search engine infrastructure 302. Crawler 301 systematically browses the World Wide Web (WWW) and client devices 312, typically for the purpose of building a database of stored content. Crawler 301 uses a list of links (pointers) such as uniform resource locators (URLs) or global network routes (GNRs), provided by link module 303, to visit web pages or client devices. The pointers are called seeds as they start a process of content discovery and typically are provided by domain registrations or client device registries. In one embodiment, as the crawler visits these pointers, a source-based downloader to download the content is selected. For example, client device downloader module(s) 313 download content which includes a pointer to identified content hosted by one or more client devices 312. Traditional web pages stored on web servers 310 are downloaded by web page downloader module(s) 304. The downloader modules download and parse the URLs to identify unique hyperlinks in the content (page) which point to stored content. URLs are typically recursively visited according to a set of policies which detect structure and content. As links are traversed, web pages and specific content are downloaded by client device downloader module(s) 313 and web page downloader module(s) 304 as per a schedule dictated by scheduler module 305. While illustrated as separate downloader modules, in one embodiment, downloader modules 304 and 313 are combined to form a combined downloader module.

Downloader module(s) 313 and 304, in one embodiment, further include preprocessing of content (e.g., webpages). Preprocessing, typically performed by web server(s) 310, includes extracting, for example, non-text information about images. Information about the image can be passed directly to the database structures 307 through the download processor 306.

Download processor module 306 reverse indexes selected content to encode words (e.g., frequency) and notes location on the associated page (offset) so that content can be recovered (extracted) at a later time (similar to reverse indexing discussion previously provided with respect to FIG. 2). The indexed data, along with any received preprocessed data, is transferred to database structure 307 where it is stored for later access by search engine(s) 308.

In one or more embodiments, database structures 307 include indexes of unique words with associated index pointers (URLs) and web page position information. Unique words are hashed using a hash table. A hash table (also hash map) is a data structure used to implement an associative array, a structure that can map keys to values. A hash table uses a hash function to compute an index into an array of buckets or slots, from which the correct value can be found.

Internet Network 309 is a global system of interconnected computer networks that use the standard Internet protocol suite (TCP/IP) to serve billions of users worldwide. Internet Network 309 interconnects web servers 310, user searching devices 311 and client devices 312, to the search system infrastructure (301 and 302) which use the indexed data to match a user input search string from user search device 311 (e.g., smartphone, tablet, laptop, desktop or other known or future user devices with communications capabilities).

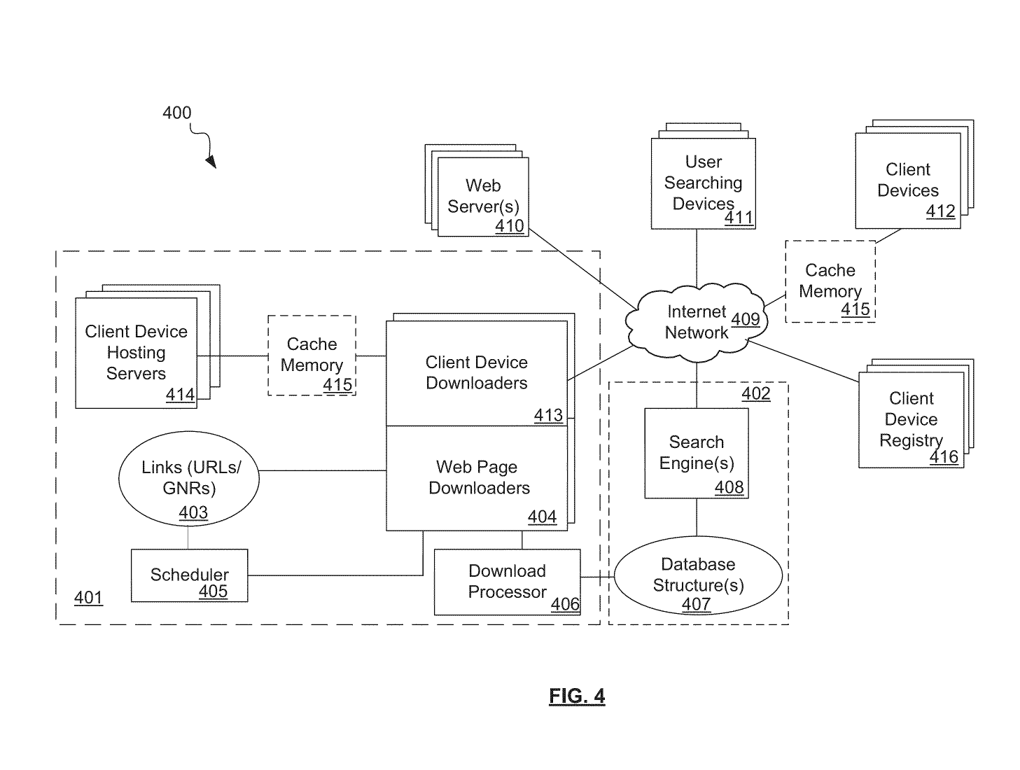

FIG. 4 is an internet search infrastructure diagram illustrating yet another embodiment in accordance with the present disclosure. Internet search infrastructure 400 includes a search system infrastructure including crawler 401 and search engine infrastructure 402. Crawler 401 systematically browses the World Wide Web (WWW) and client devices 412, typically for the purpose of building a database of stored content. Crawler 401 uses a list of web links (pointers) such as uniform resource locators (URLs) or global network routes (GNRs), provided by link module 403, to visit web pages or client devices. The pointers are called seeds as they start a process of content discovery and typically are provided by domain registrations or client device registries 416. In one embodiment, as the crawler visits these pointers, a source-based downloader to download the content is selected. For example, client device downloader module(s) 413 downloads content which includes a pointer, for example URL or global network route to content stored (in memory) on one or more client devices 412. Traditional web pages stored on web servers 410 are downloaded by web page downloader module(s) 404. The downloader modules download and parse the pointers to identify unique links (e.g., hyperlinks) in the content or page which point to stored content. Pointers are typically recursively visited according to a set of policies which detect structure and content. As links are traversed, web pages and specific device hosted content are downloaded respectively by web page downloader module(s) 404 and client device downloader module(s) 413 as per a schedule dictated by scheduler module 405. While illustrated as separate downloader modules, in one embodiment, downloader modules 404 and 413 are combined to form a combined downloader module.

Downloader modules 413 and 404, in one embodiment, further include preprocessing of content (e.g., webpages). Preprocessing, typically performed by web server(s) 410, includes extracting, for example, non-text information about images. Information about the image can be passed directly to the database structures 407 through the download processor module 406.

Download processor 406 reverse indexes a selected web page (content) to encode words (e.g., frequency) and note location on the associated page (offset) so that content can be recovered (extracted) at a later time (similar to reverse indexing discussion previously provided with respect to FIG. 2). The indexed data is transferred to a search engine database structure 407 where it is stored for later access by search engine(s) 408.

In one or more embodiments, database structures 407 include indexes of unique words with associated index pointers (URLs) and web page position information. Unique words are hashed using a hash table. A hash table (also hash map) is a data structure used to implement an associative array, a structure that can map keys to values.

Internet Network 409 is a global system of interconnected computer networks that use the standard Internet protocol suite (TCP/IP) to serve billions of users worldwide. Internet Network 409 interconnects web servers 410, user searching devices 411 and client devices 412, to the search system infrastructure (401 and 402) which use the indexed data to match a user input search string from user search device 411 (e.g., smartphone, tablet, laptop, desktop or other known or future user devices with communications capabilities).

In one or more embodiments of the technology described herein, internet search infrastructure 400 includes client device generated and, in one or more embodiments, hosted data. Client device generated data includes creation of content by users of client devices 412 (e.g., mobile communication devices 102 to 104). Once new content is created by the client device, the data is stored locally in memory (e.g., on the client device 412 with an associated pointer to the content) or remotely in remote storage (e.g., using the search system infrastructure and/or in the cloud including third party storage systems (servers)). Created content, in one embodiment, includes downloaded content or aggregated content on the client device.

For various reasons, client devices are not always accessible, for example, they become unavailable because of: low battery life, they are busy, have poor network connections, interference, choose to be not accessible (do-not-disturb), memory becomes full, are in disrepair, etc. In these situations, the device hosted content becomes unavailable to users searching for and desiring access. To increase the accessibility, the content can either be downloaded to third party storage systems 414 or cached in cache memory 415. Third party storage systems 414 can be located remotely or within the search system infrastructure (as shown). In one or more embodiments, cache 415 is illustrated to be outside the search system infrastructure or inside the search system infrastructure. In addition, in an exemplary embodiment, caching can be performed at the cache memory located at both locations or, in an alternative embodiment, in a remote location (not shown) and connected by communication networks.

Client device information, in one embodiment, is provided to a client device registry 416, for example a registry maintained by a cloud based service. Client device information includes, but is not limited to, client device identification, global network route, client type, and client status. The client device information stored within memory in the client device registry is accessible by the search system infrastructure to assist in providing access to content created/hosted on client devices 412.

Client devices 412 include, but are not limited to: mobile phones; smartphones; tablets; laptops; desktops; or other known or future user computing devices with communications capabilities. These mobile communication devices are, in one or more embodiments, a mobile phone such as a cellular telephone, smartphone, a local area network device, a personal area network device or other wireless network device, a personal digital assistant, a personal computer, a laptop computer, wearable computers (e.g., heads-up display (HUD) glasses), tablet computers or other devices that perform one or more functions that include communication of voice and/or data via a wireline connection and/or the wireless communication path. Additionally, in one or more embodiments, mobile communication devices are an access point, base station or other network access device that is coupled to a network such as the Internet or other wide area network, either public or private, via a wireline/wireless connection.

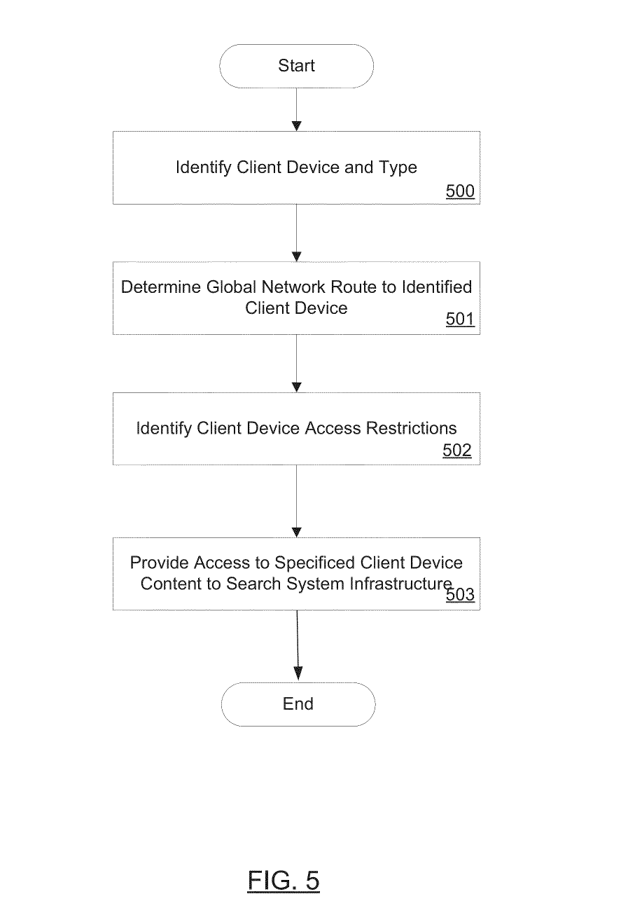

FIG. 5 illustrates a client device flow diagram showing one embodiment in accordance with the present disclosure. Once client device hosted content is created and stored within memory, the client device follows various steps in order to make the client device hosted content available to search requestors (211). In step 500, the client device provides their client device identification (ID) and type (e.g., smartphone, tablet, specific OS, device parameters) to the search system infrastructure. In step 501, a global network route to the identified client device content is determined in order to provide a pointer for the search engine to provide to a search requestor to access both the client device as well as specified content. In step 502, client device access restrictions are provided, for example, access restrictions (login ID, password, public or private security keys, etc.). Client device information obtained in steps 500-502, in one embodiment, is provided to a client device registry, for example a registry maintained in a cloud based service. The client device registry accessible by the search system infrastructure is, in one or more embodiments, part of the search system infrastructure, connected to the search system infrastructure by networks or operated by third party systems. The location of the client device registry can be a single location or be distributed without departing from the scope of the technology described herein. In step 503, access to specified client device hosted content is provided to the search system infrastructure.

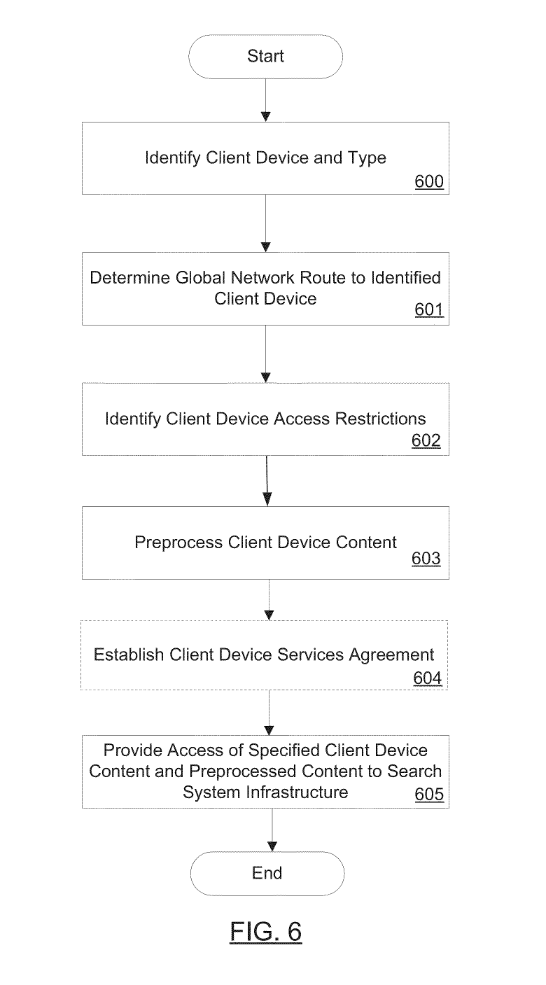

FIG. 6 illustrates a client device flow diagram showing another embodiment in accordance with the present disclosure. Referring to FIG. 6, once client device hosted content is created, the client device follows various steps in order to make the client device hosted content available to search requestors (211). In step 600, the client device provides client device identification (ID) and type (e.g., smartphone, tablet, specific OS, device parameters) to the search infrastructure. In step 601, a global network route to the identified client device content is determined in order to provide a pointer for the search engine to provide to a search requestor to access both the client device as well as specified content. In step 602, client device access restrictions are also provided, for example, access restrictions (login ID, password, public or private security keys, etc.). Client device information obtained in steps 600-602, in one embodiment, is provided to a client device registry, for example a registry maintained in a cloud based service (as previously described). In step 603, client device hosted content is preprocessed at the client so to provide, for example, a preview of images available by providing thumbnails of the images, small excerpts of text or a video preview. In optional step 604, the client device enters into a client device services agreement. With a client device services agreement, the client device will provide a copy to a third party storage system of client device hosted client content for the purposes of providing a higher probability that their client device hosted content will be available, for the purposes of providing large scale access and/or as a backup or for the purposes of collecting royalties (payment). In step 605, access to specified client device hosted content (at the client or third party server) is provided to the search infrastructure.

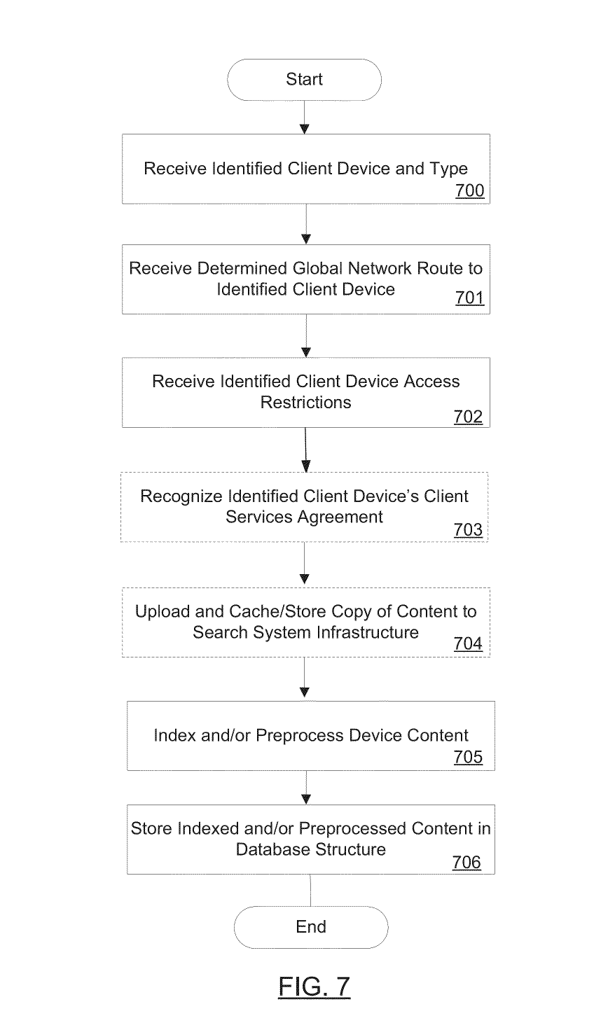

FIG. 7 illustrates a search system infrastructure flow diagram showing one embodiment in accordance with the present disclosure. Referring to FIG. 7, once client device hosted content is created, the search system infrastructure follows various steps in order to make the client device hosted content available to search requestors (211). In step 700, the system obtains client device identification (ID) and type (e.g., smartphone, tablet, specific OS, device parameters). In step 701, a global network route to the identified client device content is determined in order to provide a pointer for the search engine to provide to a search requestor to access both the client device as well as specified content. In step 702, client device access restrictions are acquired, for example, access restrictions (login ID, password, public or private security keys, etc.). Client device information obtained in steps 700-702, in one embodiment, is obtained (received from) a client device registry, for example a registry maintained in a cloud based service (as previously described). In optional step 703, the search system infrastructure recognizes an identified client device's client services agreement (previously described) and will determine a preferred location for accessing the client device hosted content. In optional step 704, access to content is obtained and at least a portion is uploaded or cached in the search infrastructure. In step 705, the client device hosted content is indexed and/or preprocessed. In step 706, the indexed and/or preprocessed client device content is stored in the search database to be accessed by the search engine.

In an embodiment of the technology described herein the wireless connection can communicate in accordance with a wireless network protocol such as Wi-Fi, WiHD, NGMS, IEEE 802.11a, ac, b, g, n, or other 802.11 standard protocol, Bluetooth, Ultra-Wideband (UWB), WIMAX, or other known or future wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other known or future mobile wireless protocol or other wireless communication protocol, either standard or proprietary. Further, the wireless communication path can include separate transmit and receive paths that use separate carrier frequencies and/or separate frequency channels. Alternatively, a single frequency or frequency channel can be used to bi-directionally communicate data to and from the mobile communication device.

In one embodiment, client devices are in communication with a search server to provide current status information of the client devices. Status information is transmitted from the individual client devices to the search infrastructure. Each client device is identified by its client device identification (ID) and, when transmitted, the status information corresponding to the client device ID is recorded. In another embodiment, transmitted client device status information replaces the previous client device status information to ensure that the information is current. In accordance with yet another embodiment, the client device search information is transmitted to the search infrastructure in real time. Status information for client device 212 includes, for example, sleep, offline, predicted period of availability, do-not-disturb (DnD), power availability, or busy along with other status indications. In one embodiment, the status information is also stored and updated within the client device registry.

While the technology described herein is generally described using mobile communications devices, non-mobile client devices such as PCs, and other computing client devices are within the scope of the technology described herein and in one or more embodiments create, receive, edit, store, and manage client hosted content.

Throughout the specification, drawings and claims various terminology is used to describe the one or more embodiments. As may be used herein, the terms “substantially” and “approximately” provides an industry-accepted tolerance for its corresponding term and/or relativity between items. Such an industry-accepted tolerance ranges from less than one percent to fifty percent. Such relativity between items ranges from a difference of a few percent to magnitude differences. As may also be used herein, the terms “client device”, “client” and “client device host” are considered equivalent.

As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The technology as described herein has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed technology described herein. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed technology described herein. One of average skill in the art will also recognize that the functional building blocks, and other illustrative blocks, modules and components herein, can be implemented as illustrated or by discrete components, application specific integrated circuits, processors executing appropriate software and the like or any combination thereof.

The technology as described herein may have also been described, at least in part, in terms of one or more embodiments. An embodiment of the technology as described herein is used herein to illustrate an aspect thereof, a feature thereof, a concept thereof, and/or an example thereof. A physical embodiment of an apparatus, an article of manufacture, a machine, and/or of a process that embodies the technology described herein may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While particular combinations of various functions and features of the technology as described herein have been expressly described herein, other combinations of these features and functions are likewise possible. The technology as described herein is not limited by the particular examples disclosed herein and expressly incorporates these other combinations.

1. A system supporting searching of content hosted by client devices comprising:
a crawler to access and index the content hosted by the client devices, the crawler comprising:
one or more downloader modules to crawl and parse the content hosted by the client devices;
a scheduler module to schedule the crawling and parsing steps;
a link module to provide links to the one or more downloader modules; and
a download processor module to index the crawled and parsed content hosted by the client devices to produce indexed data;
a database structure to store the indexed data; and
one or more search engines to search the database structure and provide search results including at least one instance of the content hosted by the client devices to a search requestor device.

2. The system of claim 1, further comprising a client device registry accessible by the system, the client device registry comprising one or more of: client device identification, client device global network route, client device type and client device status.

3. The system of claim 2, wherein the client device registry is maintained by a cloud based service.

4. The system of claim 1, further comprising a preprocessor to preprocess content hosted by the client devices.

5. The system of claim 1, further comprising a cache memory for temporarily storing at least part of the content hosted by the client devices.

6. The system of claim 1, wherein the client devices are mobile client devices with communications capabilities.

7. The system of claim 1, wherein the crawler module further comprises both a client device crawling module and web crawler module to access and index both the content hosted by the client devices and world-wide-web content.

8. A method performed by a client device, the method comprising:
communicating client device identification to a search system infrastructure;
communicating a global network route to access content hosted by the client device to the search system infrastructure;
communicating client device access restrictions to the search system infrastructure; and
providing access to the content hosted by the client device to the search system infrastructure using the communicated client device identification, global network route and client device access restrictions.

9. The method of claim 8, further comprising communicating client device type to the search system infrastructure.

10. The method of claim 8, further comprising the client device access restrictions comprising one or more of: login ID, password, public, and private security keys.

11. The method of claim 8, further comprising storing one or more of: the client device identification, the global network route, client device type, and client device status in a client device registry accessible by the search system infrastructure.

12. The method of claim 8, further comprising the client device preprocessing the content hosted by the client device.

13. The method of claim 8, further comprising securing third party storage space for storing the content hosted by the client device.

14. The method of claim 13, further comprising the secured third party storage space providing one or more of: higher probability of access to the content hosted by the client device, large scale access, backup of the content hosted by the client device, and a vehicle for collecting royalties or payments.

15. A method performed by a search system to access content hosted by a client device, the method comprising:
obtaining client device identification;
obtaining a global network route to the identified client device;
obtaining access restrictions of the identified client device;
accessing content hosted by the identified client device using the communicated client device identification, global network route and client device access restrictions;
indexing accessed content; and
storing the indexed accessed content in a search database accessible to one or more search engines.

16. The method of claim 15, further comprising obtaining client device type.

17. The method of claim 15, further comprising obtaining one or more of the: the client device identification, the global network route, client type, and client status from a client device registry accessible by the search system.

18. The method of claim 17, wherein the client device registry is maintained by a cloud based service.

19. The method of claim 15, further comprising preprocessing the accessed content.

20. The method of claim 15, further comprising recognizing a storage system storing one or more parts of the content hosted by the identified client device remotely from the identified client device.
